(19) United States
(12) Patent Application Publication
(10) Pub. No.: US 2013/0247459 A1
(43) Pub. Date: Sep. 26, 2013

(54) VASE

(71) Applicant: Margaret Egiziaco, White Plains, NY (US)

(72) Inventor: Margaret Egiziaco, White Plains, NY (US)

(21) Appl. No.: 13/429,918

(22) Filed: Mar. 26, 2012

(51) Int. Cl. A01G 5/00

(52) U.S. Cl. 47/41.11; 47/58.1 CF

(57) ABSTRACT

Devices and method for arranging objects for display in a container such as a vase. The top designed to be utilized on a particular vase includes holes in locations selected for a particular arrangement. The top can be integrated into the vase, designed for removal, or a separate device. A false bottom in the vase enables accurate cutting of the length of the objects to be inserted. In addition a method for utilizing the devices to properly arrange the objects is disclosed.

### BACKGROUND

Arranging flowers in a vase is a skill which is unknown to many if not most people. In addition, with more and more flowers being purchased at stores which are not florists, the flowers are frequently not arranged or are poorly arranged. Even if arranged in a bundle, placing them in a poorly selected vase can result in a less than optimum presentation.

### SUMMARY

The present invention provides vases and methods to ensure a beautiful arrangement of the flowers. The vase has strategically placed holes in a top on the vase which may be at various heights from the bottom of the vase. By following simple directions provided with the vase, anyone can create a beautiful arrangement of flowers. The vase with its top can be used to arrange live flowers, dried flowers, or human made flowers of any material. And it can also be used to arrange any object desired to be displayed with a stem like piece/section and a display piece at one end.

### BRIEF DESCRIPTION OF DRAWINGS

FIG. 1 is a front perspective view of a vase with a top for arranging flowers.

FIG. 2 is a side view of a vase with flower arranging top.

FIG. 3 is a cross section of FIG. 2.

FIG. 4 is another embodiment of a vase with a removable flower arranging top.

FIG. 5 is another embodiment of a different shape of the vase.

FIG. 6 is another embodiment of a removable top for placement on existing vases.

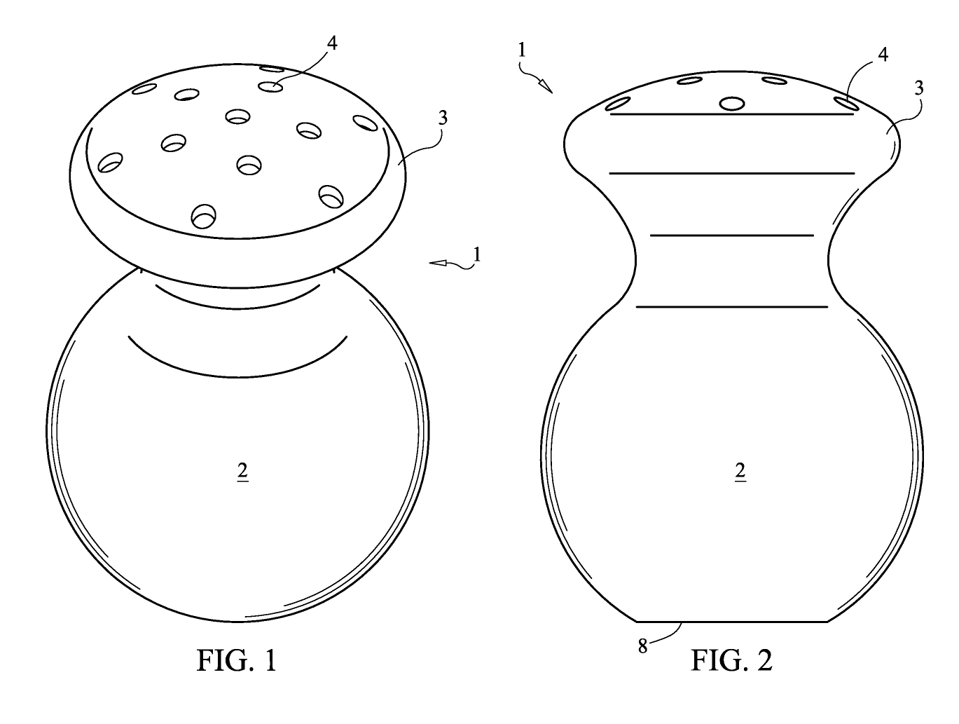

### DETAILED DESCRIPTION

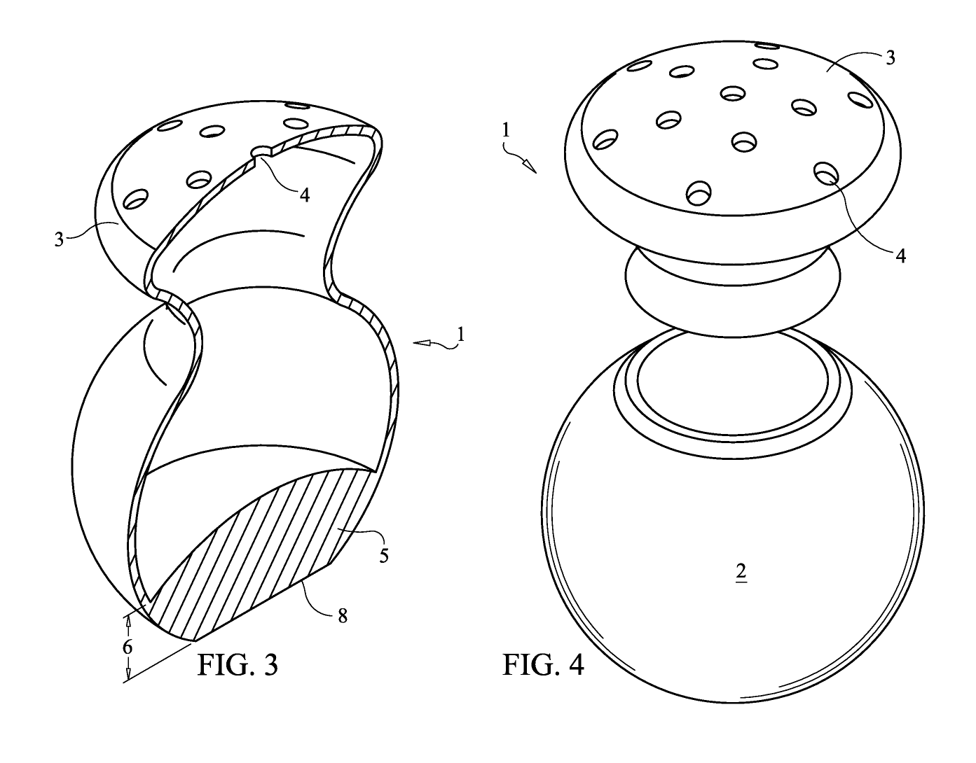

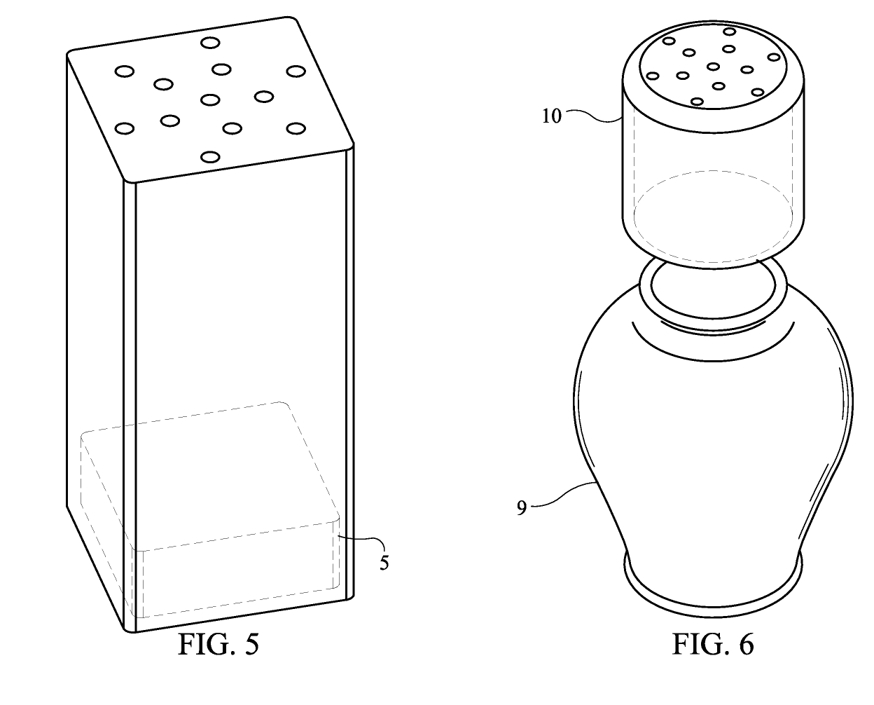

As shown on the figures, the vase includes a vase body (2) designed typically for the retention of water. The vase also has a top (3) which includes strategically placed holes (4) for the insertion of flowers' or other objects' stems. To further facilitate the easy arrangement of the flowers at the proper height, a false bottom (5) (or a raised bottom) is provided as shown on FIG. 3. The height (6) and shape of the false bottom (5) (or raised bottom) is selected based on the shape of the top (3) and the desired distance above the top of the vase (7) that an object to be inserted is to extend above the top, for example the height of a flower above the top when the stem of the flower is resting on this false bottom (5).

The top (3) can also be designed to be removable from the body (2) of the vase (1) as shown on FIG. 4. Many configurations are possible and known to those skilled in the art for joining the top (3) to the body (2). A few examples are:
1. a taper from the outer surface of the wall on the body (2) toward its inner surface with a corresponding reverse taper on the wall of the top (3);
2. a top (3) designed to screw onto the body (2); and
3. an indentation creating a ledge on the body (2) on which the top (3) is designed to rest.

A mechanism to secure the top in a position when resting on the top is provided in other embodiments. Many configurations for the mechanism to secure a top in one position are also possible and known to those skilled in the art. For example, for #1 and #3 above, a protrusion on the body (2) and a corresponding slot on the top (3) would secure the top in one position. A latch mechanism mounted to one part and then secured to the second part is another possible configuration.

Vases can be configured in almost any shape and size. FIG. 4 shows an embodiment with a different shape. But all vases have at least one opening above the height of the area to be used for water retention. A top (3) with its strategically placed holes can be designed for any openings in an upper region of the vase which if to be used for flowers is above the intended water level.

As shown in FIG. 6, a top can also be designed for placement on existing vases. The dimensions, shape and configuration of the top can be designed to fit any existing vase especially the typical openings on many readily available vases. If desired, a false bottom can be created in the existing vase by adding material such as beads, marbles, fiber board, or other material on the bottom of the existing vase.

Tops of different designs, colors, and configurations can be used as warranted based on the season, occasion, location of the vase, type of objects to be inserted, etc.

To use this vase (1) with a flower arranging top (3) and false bottom (5), each flower is held next to the vase (1) with its top (3) on with the flower at the height of the hole in the top into which it is to be inserted. The stem is then cut at the length corresponding to the bottom of the vase (8) or edge of table on which it is resting. The top can also be used without a false bottom but the method to cut flowers to proper height is different.

The size, shape, configuration, and the number, size and location of holes are designed for a particular intended type arrangement. The intended type arrangement is identified to a buyer and the vase includes instructions for its use to properly arrange the flowers.

Although several embodiments described above and by the claims serve to illustrate various concepts, components and techniques which are the subject of this patent, it is apparent to those of ordinary skill in the art that other embodiments incorporating these concepts, components and techniques may be used. It is understood that the scope of the following claims are not limited to the described embodiments and that many modifications and embodiments are intended to be included within the scope of the following claims. In addition the specific terms utilized in the disclosure and claims are used in a generic and descriptive sense and not for the purpose of limiting the invention described in the following claims.

1. A vase comprising a body;
a top on the body; and
a minimum of two holes on the top wherein the holes are strategically located for an intended arrangement of objects inserted into the holes.

2. A vase according to claim 1 wherein the top is designed to rise toward its center.

3. A vase according to claim 2 further comprising a false bottom in the vase.

4. A vase according to claim 3 wherein the false bottom is shaped to rise toward its center.

5. A vase according to claim 4 wherein the height of the false bottom is designed to be equal to an intended distance above the top at which an object to be inserted is to extend beyond the top.

6. A vase according to claim 5 in which the objects to be inserted are flowers.

7. A vase according to claim 5 wherein the top has a minimum of three holes.

8. A vase according to claim 7 wherein the design, color and configuration of the top are based on an intended use and time of year.

9. A vase according to claim 1 further comprising a false bottom in the vase.

10. A vase according to claim 9 wherein the height of the false bottom is designed to be equal to an intended distance above the top at which an object to be inserted is to extend beyond the top.

11. A vase according to claim 1 in which the top is designed to be removable and further comprising a false bottom.

12. A vase according to claim 11 wherein both the top and false bottom are designed to rise toward their respective centers.

13. A vase according to claim 12 further comprising a mechanism to secure the removable top in one position on the vase.

14. A top designed with a size and shape to rest on top of a vase comprising a minimum of three holes located for an intended arrangement of objects to be inserted.

15. A top according to claim 14 further comprising material for placement on an inside bottom of the vase to create a false bottom.

16. A method for arranging objects in a vase comprising selecting a vase with a top designed for that vase including a minimum of three holes on the top and a false bottom;
selecting an object for insertion in a selected hole with one end to be inserted and a portion at an opposite end intended to remain above the selected hole;
holding the object intended to be inserted next to the vase with the portion of the object which is intended to remain above a selected hole at the desired position where it is intended to be after insertion;
cut the end intended to be inserted in the selected hole at a position corresponding to an external bottom of the vase;
insert the cut end of the object; and
continue the process with other objects to be inserted in the vase until all objects are inserted.

17. A method according to claim 16 in which the top to be used is selected based on the season, occasion, location of the vase, or type of objects to be inserted.

18. A method according to claim 17 wherein the objects to be inserted are flowers.

19. A method for arranging objects in a vase comprising selecting a vase with a top designed for that vase including a minimum of three holes on the top;
adding material to create a false bottom in an inside bottom of the vase as needed;
selecting an object for insertion in a selected hole with one end to be inserted and a portion at an opposite end intended to remain above the selected hole;
holding the object intended to be inserted next to the vase with the portion of the object which is intended to remain above a selected hole at the desired position where it is intended to be after insertion;
cut the end intended to be inserted in the selected hole at a position corresponding to an external bottom of the vase;
insert the cut end of the object; and
continue the process with other objects to be inserted in the vase until all objects are inserted.

20. A method according to claim 17 wherein the objects to be inserted are flowers.
